(19) United States
(12) Patent Application Publication
(10) Pub. No.: US 2017/0180966 A1
(43) Pub. Date: Jun. 22, 2017

(54) NOTIFICATION OF EMERGENCIES BASED ON WIRELESS SIGNAL RECOGNITION

(71) Applicant: Rave Wireless, Inc., Framingham, MA (US)

(72) Inventors: William Todd Piett, Southborough, MA (US); Mathew A. Serra, Newton, MA (US)

(21) Appl. No.: 15/383,389

(22) Filed: Dec. 19, 2016

Related U.S. Application Data
(60) Provisional application No. 62/268,679, filed on Dec. 17, 2015.

(51) Int. Cl. H04W 4/22; H04W 68/00; H04W 4/02

(52) U.S. Cl. CPC H04W 4/22; H04W 4/025; H04W 68/005

(57) ABSTRACT

A method includes distributing one or more notifications of an emergency call being placed from a mobile device to emergency responders. The distribution of such notifications is based on a configurable rule set.

### RELATED APPLICATIONS

This application claims the benefit of the Dec. 17, 2015 priority date of U.S. Provisional application 62/268,679, the contents of which are herein incorporated by reference.

### FIELD OF INVENTION

This invention relates processing emergency communications, and in particular, generating notification messages in response to an emergency communication.

### BACKGROUND

The ability to simply dial 9-1-1 and to make available a dispatch-quality location for the emergency caller has long been a key requirement for the nation's 9-1-1 system. Over time, new technologies have both challenged and improved 9-1-1's ability to meet these requirements.

A complicating factor facing emergency responders is introduced by multi-line telephone systems (MLTS). In response to tragedies that have occurred as a result of phones on a multi-line telephone system not having been configured to dial 9-1-1 directly, many jurisdictions now require that callers be able to reach emergency services by simply dialing the digits “911.” This avoids confusion associated with having to first dial an extra digit to access an outside line, e.g. 8-911 or 9-911.

In many instances a trained on-site responder may be nearby and yet completely unaware of an emergency. For example, a front desk manager or on-site security officer may be trained for emergency first-aid. Such an on-site responder would not be able to do very much without knowing there is in fact an emergency.

In order to speed the response process, legislation often also requires that a multi-line telephone system not only connect 9-1-1 calls directly but to also notify an on-site responder if one is available. In such systems, when a call is made to 9-1-1 from a line on a multi-line telephone system, the multi-line telephone system not only immediately connects the call to 9-1-1 but also makes an on-site notification. Such on-site notifications can be carried out in different ways. One way is to present an alarm-message to an on-site responder through a computer-based notification, such as an email or text message sent to a designated phone, or to use another form of alarm to gain an on-site responders attention.

While the actions of the FCC, state, and local governments do represent tangible improvements, they nevertheless fail to account for the fact that over 70% of 9-1-1 calls are placed via phones that do not actually have a fixed location, i.e., from mobile phones. If an individual places a 9-1-1 call from a mobile phone, even while located at a facility served by a multi-line telephone system providing on-site notifications, the nearest responder may still not know of the incident until off-site responders arrive. This is because an on-site notification is only triggered if the multi-line telephone system is used to make the 9-1-1 call.

Known technologies used to identify a mobile caller's location can include but are not limited to trilateralization and/or triangulation off of cell tower signals or other RF signals, IP-access point identification, near-field communications, and GPS.

Wireless carriers and other solution providers are doing significant work to further improve the ability to locate emergency callers using these technologies and others, especially for callers located inside a building.

In early 2015, the FCC mandated that wireless carriers improve the accuracy of location information provided for 9-1-1 calls placed over their communications services. These more stringent requirements required the creation of a National Emergency Address Database (NEAD), an authoritative source of data that associates RF-device access points (e.g. Wi-Fi or Bluetooth base-stations) to dispatch-quality locations.

In the proposed NEAD architecture, the device or service placing the 9-1-1 call provides the carrier network with a list of the RF-device access points detected by the calling device. The carrier network queries the NEAD using this RF-access point list to retrieve the registered locations for each access point. An algorithm evaluates the list of candidate addresses, optionally in combination with the results of other location-determination technologies, to produce a single address for use by the 9-1-1 center to dispatch emergency responders.

These efforts do not include notifying on-site responders when an individual uses a mobile device to call 9-1-1 call from within a location served by a multi-line telephone system. As a result, a caller who makes the mistake of using his mobile device instead of the multi-line telephone system to make an emergency call will have the misfortune of a possibly delayed response. This is because even though an on-site responder may be only a few hundred feet away, that on-site responder would have no way to know of any emergency. This raises the uncomfortable prospect of tragedy for no other reason than choosing the wrong telephone to call for help.

### SUMMARY

In general, when an emergency occurs, it is useful to notify certain people about it. These people will generally fall into two classes. The first class includes the responders. These are the people whose job is to minimize the collateral damage associated with emergencies. Examples include police officers, firefighters, and on-site security personnel. Then there are the people who are potential victims of the emergency. For example, if a fire breaks out in one floor of a building, it may be useful to notify people on other floors so that there can be an orderly evacuation.

In the heat of the moment, it is often difficult to remember who notify and how to notify them. In the context of an emergency, it is undesirable to waste time looking up the contact information associated with all the relevant parties. Furthermore, the mobile nature of today's workforce makes it difficult to reliably track who is at a given location during an emergency. Consequently, it is advantageous to reference pre-configured rules and be able to dynamically determine the devices to target when sending critical notifications.

A networked-device emergency-notification system addresses the lack of on-site notification for 9-1-1 calls placed through a wireless communication service. While the networked-device emergency-notification system closes the notification gap in MLTS-served environments, it can be applied to any location at which the device dialing 9-1-1 can detect local wireless signals and at which there exists an interest in notifying responders of the call. Such technology can also identify devices that should receive timely and relevant notification messages, in order to deliver instructions on how to avoid a hazard, or to direct a response to the incident.

The networked-device emergency-notification system uses the device's ability to identify nearby Wi-Fi, Bluetooth, or other access points broadcasting wireless signals. The system references a database of locations associated with the identified access points, automatically identifies the appropriate individuals or systems to be notified, and notifies these identified recipients of the presence of the nearby emergency call. This system also has the ability to interrogate wireless networks to identify the location of devices within the wireless networks coverage area.

In one aspect, the invention features a method for distributing a notification of an emergency communication to a recipient set by receiving the emergency communication, extracting information from the received emergency communication, providing the extracted information to a configurable rule set, causing the configurable rule set to identify the recipient set, and distributing a notification to one or more members of the recipient set.

Among these are practices in which the emergency communication includes an emergency call placed from a mobile device, a text message, or an alarm signal transmitted by an alarm-actuator. In some of these practices receiving an alarm signal transmitted by an alarm-actuator includes receiving an indication that a panic button on a device has been pressed. This panic button, in some practices, is a soft panic button such as one that is displayed on a screen of said device. However, in other practices, the panic button is a hardware panic button. In yet other practices, receiving the emergency communication includes receiving a signal indicative of expiration of a safety timer, or receiving a signal indicative of an abnormal or unsafe event. Examples of signals indicative of abnormal or unsafe events include receiving a signal from a smoke detector, receiving a signal from a fire detector, or receiving a signal indicative of activation of a sprinkler system.

Practices of the invention also include those in which the recipient set includes all persons connected local area network identified based on information in the emergency communication, those in which it includes all persons identified as being in a particular area, the particular area having been identified based on information in the emergency communication, those in which it includes all persons identified in a list of persons, the list of persons having been identified based on information in the emergency communication, those in which it includes emergency responders, and those in which it includes personnel to be evacuated as a result of the emergency. As used herein, any reference to a person is deemed to correspond to a reference to a communication device that that person is expected to be able to use to receive a notification message.

In some practices, the emergency communication includes information indicative of an area affected by the emergency.

Other practices include, using the rule set, evaluating a location associated with the emergency communication. Among these practices are those that further include, based on the rule set, evaluating notification recipients associated with the location. Also among these practices are those in which evaluating a location associated with the emergency communication includes evaluating a location of the mobile device, those in which it includes evaluating a location of at least one wireless signal-originating access point discovered by the mobile device, and those in which evaluating the location includes identifying it via a civic address, via geodetic coordinates, and/or via a geodetic circle or polygon.

Some practices include, based on the rule set, evaluating a unique identifier of a wireless signal-originating access point discovered by a mobile device that has sent the emergency communication. Among these are those in which evaluating this unique identifier includes identifying the access point by a Media Access Control (MAC) Address, identifying it by a Base Station Identifier (BSID), and identifying it with a Universally Unique Identifier (UUID), and identifying the access point by a wireless signal identifier that can be discovered by a mobile device and used to uniquely identify the source of the wireless signal.

Other practices include, based on the rule set, identifying an attribute associated with the access point. Examples of such attributes include a name of a network to which the access point belongs, a strength of a signal provided by the access point, a direction of a signal provided by the access point, and a type of network to which the access point belongs. Examples of evaluating a type of network include determining that the network is a Bluetooth network and determining that the network is Wi-Fi network.

Among the practices that include evaluating notification recipients associated with a location are those that include doing so by identifying an email address of a notification recipient, identifying a phone number of a notification recipient, identifying an SIP URI of a notification recipient, identifying an Instant Messenger ID of a notification recipient, identifying a web service of a notification recipient, and identifying either a device token or a platform-specific unique identifier for delivering a notification via a mobile phone application.

In any of the foregoing practices, the notification recipient can be a device associated with an individual, devices corresponding to a group of individuals, a device associated with an organization, or devices intended to broadcast an alert, such as a siren, an annunciator, a digital sign, or a kiosk.

Also among the practices of the invention are those that include, based on the rule set, evaluating a mode by which a notification is to be sent to a first notification recipient, and, using the mode, sending the notification to the first notification recipient. Among these are practices in which evaluating a mode includes identifying an electronic message delivery mode, some examples of which include email via SMTP, SMS via SMPP, SMS via SMTP, a mode for sending Common Alerting Protocol formatted messages, a mode that permits delivery of a message to be displayed within a mobile phone application, a mode that permits deliver of an audio message, and a mode that permits delivery of a video message.

Other practices include, based on the rule set, identifying when the emergency communication took place. This includes identifying a time, a day of the week, a month, and a calendar date.

Yet other practices include, based on the rule set, evaluating the nature of the reported emergency, or evaluating an attribute of the caller. Examples of attributes that can be identified include a medical condition or disability associated with the caller, as well as a caller's affiliation with an organization, including a caller's role within an organization.

In another aspect, the invention features a method including managing a rule set that controls when a notification is sent in response to an emergency communication being placed from a mobile device.

Among the practices of the foregoing method are those in which managing a rule set includes managing the rule set via a user interface, those in which managing a rule set includes managing the rule set via an application programming interface, and those in which managing a rule set includes managing the rule set via a batch process.

In another aspect, the invention features a method comprising processing an emergency communication by receiving the emergency communication, receiving information indicative of a location of an emergency, providing the extracted information to a configurable rule set, using the configurable rule set, generating a recipient list that identifies at least one recipient of a notification message based on the received emergency communication, and distributing the notification message to at least one recipient from the recipient list. Receiving information indicative of a location of an emergency includes receiving information indicative of a device that was used to convey that emergency communication. Examples of information indicative of a device include information indicative of its signal strength, of a unique identifier thereof, or of a unique identifier for that device.

Among the practices of the invention are those that in which receiving the emergency communication comprises receiving an emergency call placed from a mobile device, receiving a text message, and receiving an alarm signal transmitted by an alarm-actuator. Examples of an alarm actuator include pressing a button or otherwise actuating a hardware actuator, performing a similar function on a software actuator, such as a panic button displayed on a device screen, for example by a phone app executing on the device. Also included among alarm actuators are those that are triggered by an event other than one initiated by a user. For example, the alarm actuator may be triggered by lapse of a safety timer or by detection of an abnormal event.

In some practices, generating the recipient list comprises including, in the recipient list, a device that is able to communicate with at least one emergency responder, all devices connected to a particular local area network that has been identified based on information in the emergency communication, and devices associated with all persons in a particular area, the particular area having been identified based on information in the emergency communication.

In other practices, generating the recipient list includes identifying all persons in a list of persons, the list of persons having been identified based on information in the emergency communication.

In yet other practices, generating the recipient list includes adding devices that are not necessarily associated with any person, such as sirens, kiosks, digital signs, and other devices that are intended to broadcast a notification message to a set of persons.

Among the practices of the invention are those in which receiving information indicative of a location of an emergency includes receiving information from the received emergency communication, and those in which receiving such information includes receiving it from the National Emergency Address Database.

Also among the practices of the invention are those in which receiving information from the received emergency communication comprises evaluating a unique identifier of a wireless signal-originating access point discovered by a mobile device that has sent the emergency communication, and inferring a location based on the unique identifier.

As used herein, the term “communication” is a collective noun that is not defined by how the information associated with a communication is packaged. In particular, a “communication” is not a discrete entity but can include one or more individual communication events of different types.

In other practices, the received information can be obtained in the course of different communication events that occur during the emergency communication. For example, in some practices, the received information arises from a second communication event that follows in response to interrogating the device that initiated the communication.

For example, in some practices, receiving information indicative of an emergency comprises receiving the information from the emergency communication. In others, receiving the information indicative of an emergency includes requesting information in response to the emergency communication. And in other practices, receiving information indicative of an emergency includes requesting said information from a network that was used during conveyance of said emergency communication.

Other practices include those in which distributing a notification message comprises evaluating a mode by which a notification is to be sent to a notification recipient from the recipient list and, using the mode, sending the notification message to the notification recipient.

The rule set can also be used to evaluate other information that is useful for identifying recipients of a notification message. For example, the rule set can be used to evaluate the nature of the reported emergency or to evaluate an attribute of the caller.

Practices of the invention also include those in which processing the emergency communication comprises relying, at least in part, on service provided by a wireless public telephone network, and those in which emergency communication comprises avoiding reliance on service provided by a wireless public telephone network.

Also among the practices of the invention are those that include configuring the rule set. In some practices, this is carried out via a user-interface.

In another aspect, the invention features an apparatus for processing emergency communications. Such an apparatus includes a processing system and memory in data communication with the processing system. These both are physical structures that are made of matter, that consume energy, and that give off waste heat. To the extent that there exist incorporeal embodiments of processing systems and memory, those incorporeal embodiments are disclaimed. The claims only cover tangible and non-transitory embodiments of a processing system and memory. The processing system is one that is configured to extract information from a received emergency communication. It includes a machine-readable medium tangible and non-transitory. This tangible and non-transitory machine-readable medium has, encoded thereon, data representative of a configurable rule set having rules that cause the processing system to generate a recipient list that identifies at least one recipient of a notification message. These rules are not implemented as software per se. Instead, they are implemented as software per quod. The processing system is further configured to distribute the notification message to the at least one recipient. This distribution involves manipulation of matter, for example by causing generation of an electromagnetic wave that has been modulated in a manner that is interpreted by a receiving unit as a notification message.

In some embodiments, the processing system is further configured to receive, from a location-determining platform, information indicative of location from which the emergency communication originated. This information would be carried on a physical signal.

In other embodiments, is further configured to receive information indicative of at least one wireless access point and to infer a location from which the emergency communication originated based at least in part on the information. Such information can arise, for example, as a result of having queried the network for such information.

In another aspect, the invention features a manufacture comprising a tangible and non-transitory computer-readable medium having encoded thereon instructions that, when executed by a digital computer processing system, cause the digital computer processing system to extract information from a received emergency communication, to execute at least one rule from a configurable rule set having rules that cause the processing system to generate a recipient list that identifies at least one recipient of a notification message, and to distribute the notification message to the at least one recipient. These instructions are not implemented as software per se. They are implemented as its converse, namely software per quod.

The methods and systems described herein can be implemented abstractly or non-abstractly. The appended claims are hereby restricted only to non-abstract implementations.

### BRIEF DESCRIPTION OF THE DRAWINGS

These and other features and advantages of the invention will be apparent from the following detailed description and the accompanying figures, in which:

FIG. 1 shows an example of an environment that benefits from the a notifier;

FIG. 2 shows how a notifier fits into an existing E911 network;

FIG. 3 shows a process executed by the notifier of FIG. 2;

FIG. 4 shows the notifier of FIG. 2 but with the act of determining location being carried out in part by network interrogation; and

FIG. 5 shows the notifier of FIG. 3 being used to identify all devices connected to a network.

### DETAILED DESCRIPTION

Emergency communications can take many forms. As used herein, an emergency communication is any communication made by an individual or a device to inform emergency personnel about an emergency. In some cases, the emergency communication may also summon emergency personnel. Emergency communications include communications such as voice or audio calls, a video calls, text-based communications, machine-to-machine communications, automated detection of abnormal or unsafe events, a user initiated action such as a hardware or software button press, or the lapse of a previously configured safety timer. The term “emergency call,” as used herein, is equivalent to “emergency communication.”

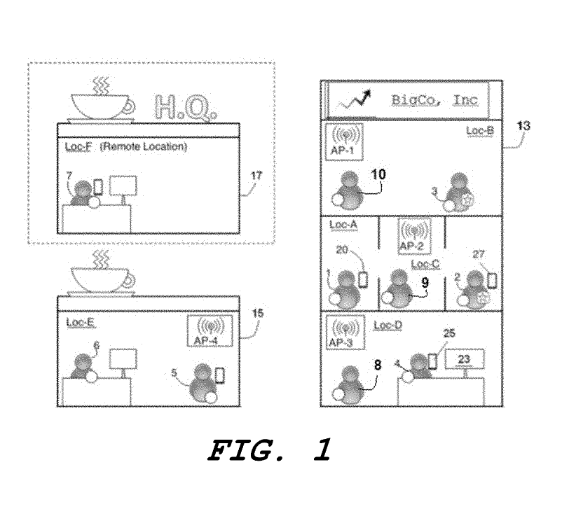

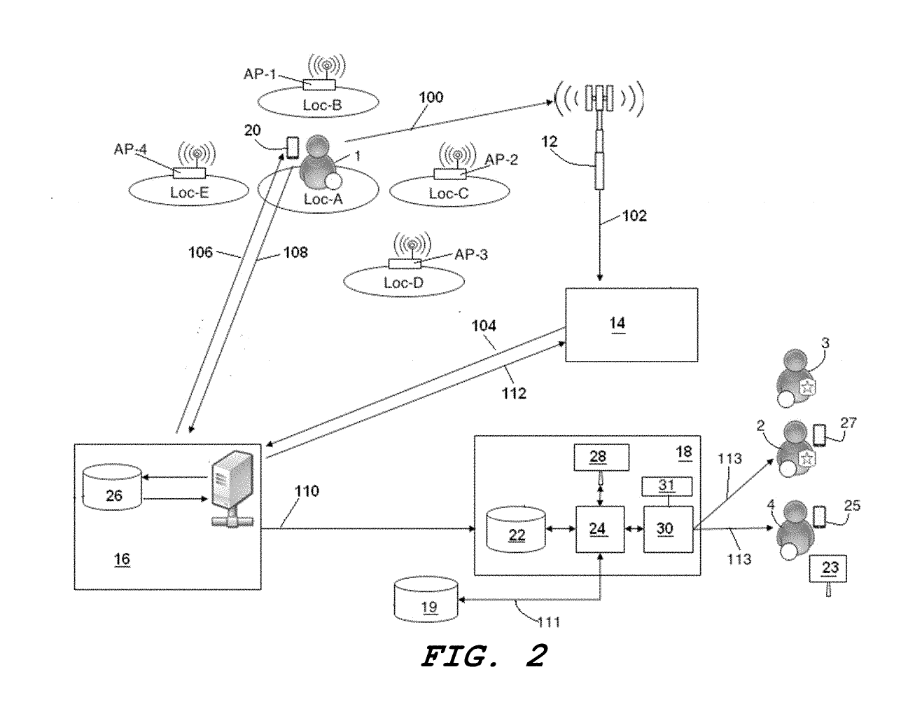

FIG. 1 shows an example of an environment that would benefit from a networked-device emergency-notification system 18 shown in FIG. 2 and hereafter referred to as a “notifier.” Other examples of such environments include: educational facilities, recreational facilities, theaters, museums, arenas, government facilities, corporate campuses, group living/apartment and condominium complexes, hospitals, assisted living facilities, and outpatient facilities. These environments may include natural or manmade structures and open areas of the described environment. The foregoing list of examples is provided by way of example and is not intended to be exhaustive.

FIG. 1 shows an organization occupying a building 13 having first through fourth locations Loc-A, Loc-B, Loc-C, Loc-D. Each of these locations can be described by at least one of a civic address, a geodetic point, a geodetic circle, and a geodetic polygon. Such locations are thus easy to dispatch emergency personnel to when necessary. The building 13 also includes first, second, and third wireless access points AP1, AP2, AP3.

Within the building 13 are several safety and security measures. In this example, first and second on-site responders 2, 3 are assigned to the 2^{nd} and 3^{rd} floors, respectively. An on-site receptionist 4 monitors building access and to orient guests to the facility. In some cases, a receptionist 4 is available twenty-four hours a day and seven days a week.

FIG. 1 also shows a neighboring coffee shop 15 staffed by a first employee 6. The neighboring coffee shop 15 occupies a separate structure that corresponds to a fifth location Loc-E. having a fourth access point AP4.

A second employee 7 staffs a headquarters facility 17 at a remote sixth location Loc-F that oversees activities at the neighboring coffee shop 15 at the fifth location Loc-E. The sixth location Loc-F is far enough from all the other locations shown in FIG. 1 so that signals from the first, second, third, and fourth wireless access points AP1, AP2, AP3, AP4 cannot be detected at the remote sixth location Loc-F.

In case of an emergency at the coffee shop 15, it will probably not be necessary to notify everybody in the building 13. However, it may be wise to notify the first and second employees 6, 7. Thus, a recipient set, referred to herein as a recipient list 31, for notifications would include the first and second employees 6, 7. On the other hand, if the emergency occurs in the building 13, the recipient list 31 would not need to include the first and second employees 6, 7.

The notifier 18 relies on certain notification rule sets 22 to identify one or more members of a recipient list 31, all of whom are to be notified, and to do so based on information derived at least in part from the emergency call itself.

For example, in operation, the notifier 18 obtains information indicating that an emergency call has been placed from either of the first through fourth locations Loc-A, Loc-B, Loc-C, Loc-D. The particular manner in which this information is acquired is not important. For the sake of this example, it is assumed that the emergency call is accompanied by information that indicates that the device initiating the emergency call is at a location served by one of the first through third access points AP1, AP2, AP3. Based on this, the notifier executes a rule from its rule set 22 to identify who should be notified of the emergency call. In this example, the rule determines, logically enough, that the receptionist 4 should be part of the recipient list 31. This results in adding the receptionist 4 to the recipient list 31.

The notifier 18 then executes another rule from its rule set 22 to determine how to notify the receptionist 4. Based on stored information about the receptionist 4, the notifier 18 knows that the receptionist has both a mobile device 25 and a computer 23. The notifier 18 then executes a rule that causes a notification to be sent to both the mobile device 25 and to the computer 23.

The rule set 22 also recognizes whether the emergency call occurs during working hours. For example, if the notifier 18 recognizes that the emergency has occurred during working hours, it may add either the first on-site responder 2 or the second on-site responder 3 to a recipient list 31. Such a notification could take the form of a message to a mobile device associated with the corresponding on-site responder 2, 3.

The notifier 18 also uses the rule set 22 to choose which on-site responder 2, 3 to notify.

For example, if the notifier 18 receives information indicating that the caller is near the second access point AP2, or if the notifier 18 receives information indicating that the call originated from the first location Loc-A or the third location Loc-C, a rule from the rule set 22 causes the notifier 18 to notify the first on-site responder 2.

On the other hand, if the notifier 18 receives information indicating that the emergency caller 1 is now near the first access point AP1, for example because a signal strength has become stronger, it is reasonable to infer that the caller 1 is at the second location Loc-B. In that case, execution of the relevant rule from the rule set 22 will cause the recipient list 31 to include the second on-site responder 3 instead of the first on-site responder 2. The notifier 18 thus achieves the ability to define a dynamically changing recipient list 31 that will change as the caller moves from one place to another, as dictated by the relevant rule set 22.

A separate rule set can be configured for a company that operates the neighboring coffee shop 15 at the fifth location Loc-E. This rule set can be executed by either the same notifier or a separate notifier 18. An example of such a separate rule could be one that initiates creates a recipient list 31 that includes both the first employee 6 at the fifth location Loc-E and the second employee 7 at the remote location Loc-F in response to determining that a customer 5 has placed an emergency call while located in the fifth location Loc-E or while using a mobile device that is proximate to the fourth access point AP4.

In some cases, there may be some uncertainty because a particular mobile device may be close to several access points. In that case, the notifier 18 executes logic to choose between a first rule set, which attempts to notify people with great precision, and a second rule set, which implements a broader notification strategy for cases in which a precise caller location is unavailable. The use of the first rule set is useful if the notifier 18 is fairly confident concerning the location from which a call originated. However, if the notifier 18 is not confident of location, the second rule set is preferable otherwise since executing the first rule set may result in notifying only an inappropriate party. Alternatively, the uncertainty of mobile-device location could result in the notifier 18 executing logic associated with multiple rule sets, where each selected rule set falls within the broader area described by the uncertainty in the location determined for the emergency call.

For example, in some cases, a mobile device 20 used by an emergency caller 1 to place an emergency call may be able to detect wireless signals not only from the second access point AP2 but also from the first access point AP1 upstairs and possibly even the third access point AP3 downstairs. It may even detect a weak but still usable signal from the fourth access point AP4.

To resolve this ambiguity, the notifier 18 considers additional information. Examples of such additional information include relative signal strength, and location information determined by other means, such as GPS-calculated location information for the calling device. Such additional information can also include information about the mobile device 20 or the emergency caller 1. For example, knowing that the emergency caller 1 works for the organization that occupies the building 13 would provide a basis for ignoring the fourth access point AP4. Knowing that the emergency caller 1 has an office on the second floor of the building 13 would provide a good basis for including the receptionist 4 and the first on-site responder 2 on the recipient list 31.

The emergency call could include additional information. Examples of such additional information include the identity of the device 20 placing the call, the identity of the emergency caller 1, the location from which the call was placed, and combinations thereof. Under these circumstances, the first and second employees 6, 7 and the second on-site responder 3 would remain unaware of the emergency call, per previously defined rules.

Similarly, if the notifier 18 cannot conclusively identify the caller's location within the building 13, it could implement a more liberal notification rule in which more people are included in the recipient list 31. For example, using this more liberal notification rule, the notifier 18 would send a notification to the second on-site responder 3 as well as the first on-site responder 2. This would occur, for example, if the notifier 18, for some reason, could not determine that the second access point AP2 is closer to the emergency caller 1 than the first access point AP1, or if the notifier 18 cannot determine that the calling device 20 is located at the first location Loc-A rather than at the second location Loc-B.

When determining caller proximity for the purpose of generating a recipient list 31 in response to an emergency communication, the notifier 18 can consider any of the following factors either alone or in combination: the unique wireless signal identifiers, the strength of wireless signals, a unique identifier associated with signal-originating access points, the location of the signal-originating access point, information about caller attributes, and the location of the device placing the emergency call.

FIG. 2 shows one implementation of the notifier 18 operating within a sample communications environment. Other deployment options and environments are possible for the notifier 18. For example, in some embodiments, the notifier 18 receives one or more of wireless network data, location data, caller data, calling-device data, and an indication of the nature of the emergency. These can all be used as inputs to a rule set 22 that then determines the appropriate recipient list 31 and carries out the relevant notifications.

It should be noted that the figures are intended as logical representations only. There is no requirement that structures shown as separate must also be remote from each other in their physical implementations, or that they somehow belong to or are controlled by different organizations.

The illustrated process begins with an emergency caller 1 sending an emergency communication 100 from the first location Loc-A.

In the illustrated embodiment, the emergency communication is a voice call on a telephone, such as a 9-1-1 emergency call. However, other communications indicative of an emergency can be used. For example, a text message or electronic mail message can be processed in a similar way. Additionally, it is possible to transmit an emergency communication as a result of actuating an actuator. Examples of such an actuator include but are not limited to a lever on a fire alarm or a panic button on a mobile device.

A wireless service provider network 12 receives the emergency call 100 and forwards the call 102 to an emergency-response center 14. The emergency-response center 14, in an effort to receive an improved caller location to which first responders can be dispatched, sends a location-determination platform 16 a caller-location request 104.

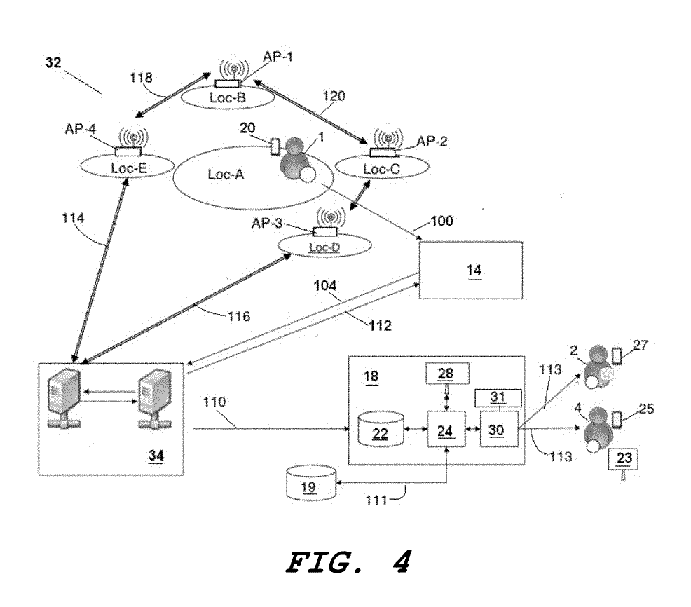

In the implementation shown in FIG. 2, the location-determination platform 16 operates within the wireless service provider network 12. However, it is possible for location-determination to be carried out in different ways. For example, if the emergency communication is a VoIP call or message, it is possible to identify the access point used by the device to infer its location using the method discussed in connection with FIG. 4.

The location-determination platform 16 transmits a location inquiry 106 to the emergency caller's device 20. In response, the caller's device 20 then returns a location response 108 to the location-determination platform 16. This location response 108 includes a list of wireless access point identifiers that the caller's device 20 is able to detect.

The location-determination platform 16 then provides a list of wireless access points to a database 26. In response, the database 26 returns location information that identifies locations associated with the retrieved wireless access point identifiers that the caller's device 20 provided in its location response 108. A suitable database 26 is the National Emergency Address Database.

After engaging in some additional calculations, the location-determination platform 16 returns a location estimate 112 to the emergency-response center 14. The emergency-response center 14 then uses this location estimate 112 to dispatch emergency responders.

Concurrent with or after updating the emergency-response center 14, the location-determination platform 16 provides the notifier 18 with first information 110 for use by the notifier 18 in generating the recipient list 31. The first information 110 includes the list of unique access-point identifiers AP1, AP2, AP3, AP4 detected by the mobile device 20 that placed the emergency call 110. However, the first information 110 can also include additional information that may be useful for generating a recipient list 31. Representative examples of such additional information include any one or more of the characteristics of the signals radiated by the access points AP1, AP2, AP3, AP4 (e.g. signal strength), the locations associated with each wireless access point Loc-B, Loc-C, Loc-D, Loc-E, the estimated location of the caller's device 20 at the first location Loc-A, information identifying the caller's device 20, and the nature of the reported emergency.

In some embodiments, the notifier 18 has access to second information 111 that can be used for generating the recipient list 31. Such second information 111 comes from an external source. In FIG. 1, the external source is a caller-attribute database 19. Examples of such second information 111 include information about medical conditions or organizational affiliation. These caller attributes may be determined by using calling-device identifying-information to identify individual(s) or organization(s) that are known to use the device.

The notifier's rule set 22 uses this additional information from the caller-attribute database 19 to compile the recipient list 31. In some practices, the notifier 18 also includes this additional information, or selected portions thereof, as part of the content of the notification message that is sent to members of the recipient list 31.

A rule engine 24 within the notifier 18 uses one or more rules from the configured rule set 22 to evaluate the first and second information 110, 111. In one example, the notifier 18 causes a notification engine 30 to trigger an email, desktop notification, and SMS text message to the receptionist 4 as well as an SMS text message and an “app push” message to a mobile app residing on a phone 27 associated with the first on-site responder 2.

The notification engine 30 provides all of the logic and functionality necessary to format a notification message 113, manage protocols, to establish and maintain connectivity, and to handle any error in the manner required by the particular notification technologies (email, SMS, CAP, etc.) specified by the rule set 22. The notification engine 30 also records the outcome of each notification attempt and makes this information available for reporting.

A rule-configuration module 28 provides the interfaces necessary to carry out certain administrative functions for managing the rule set 22 that is used to determine when to trigger notification messages 113 to message recipients. These administrative functions are implemented via a user interface, or via machine-to-machine interfaces to automate rule provisioning or to source rules from disparate systems.

The methods and systems described herein are agnostic to the nature of the recipients. Thus, in some practice, the recipient list 31 might include the occupants of a building or a subset of a building. This might be the case if, for example, a signal indicates a fire and certain people need to evacuate. Alternatively, the recipient list 31 may include all those who are connected to a particular access point or to a particular network. In some embodiments, the recipient list 32 also includes devices that are not affiliated with a specific individual. Examples of such devices include a digital sign, a kiosk, a siren, or any similar devices that are intended to be noticed by any number of individuals.

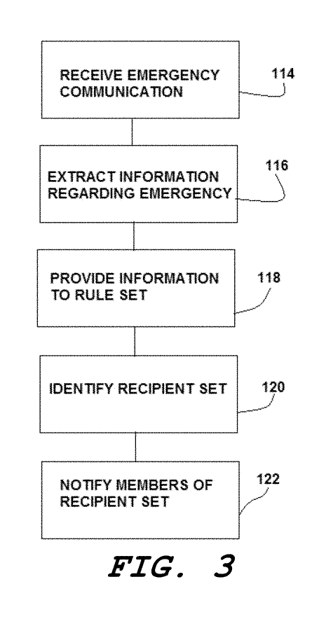

The embodiment described in connection with FIG. 2 is an example of a method shown in FIG. 3, which begins with receiving an emergency communication (step 114) and receiving information regarding the emergency (step 116). Such information might include the nature of the emergency, including its type and/or severity as well as its location or information from which its location can be obtained. For example, the information might specify a fire having a severity identified as a “one-alarm fire” at a location specified as the 30th floor of “Building 45,” where the address of “Building 45” is available in a look-up table.

This information is then provided to a configurable rule set (step 118), which uses it to identify a suitable set of recipients (step 120). For example, execution of a rule in the rule set may identify that, because the fire is a one-alarm fire, only the occupants of the 25th through 35th floors should be notified, along with a fire station one block away, the local hospital four blocks away, who may need to prepare to receive victims, security personnel on the 5th floor of the building. This set of people would then define the recipient list 31.

This is followed by the step of actually notifying one or more recipients in the recipient list 31 (step 122). Such notification can be carried out in a variety of ways depending on the particular recipient. For example, the occupants of the building might be notified by email, whereas the fire department may be notified by an automated call.

In the implementation shown in FIG. 4, there is no need to query the caller's device 20. Instead, a local network 32 to which the caller's device 20 is connected becomes the object of inquiry.

The procedure shown in FIG. 4 begins when an emergency caller 1 at the first location Loc-A sends an emergency communication 100 to the emergency-response center 14. This emergency communication 100 does not necessarily travel over the wireless service provider's network 12 or the local wireless network 32. Nor does this emergency communication 100 have to travel over the same network that is ultimately used to carry out the notification. In principle, it is possible to have two separate and distinct networks, one for locating persons to whom notifications are to be sent and another for actually sending those notifications.

Although the emergency communication 100 is illustrated as a 9-1-1 call, it need not be. For example, the emergency communication 100 can be made to a private security service without using the 9-1-1 system. Since the wireless service provider network 12 is not necessarily involved in FIG. 4, the emergency communication 100 need not be a conventional cellular telephone call at all. Instead, it can take the form of a VoIP call, an actuation of an actuator, such as a panic button on the caller's device 20, or any communication transmitted through the local network 32.

In the particular embodiment of FIG. 4, the local network 32 includes a wireless network formed by the first through fourth access points AP-1, AP-2, AP-3, AP-4 that communicate with each other via internal communication links 118, 120, of which only two are shown. A WLAN controller 34 manages the local network 32 via external communication links 114, 116. The WLAN controller 34 can be either part of the local network 32 or part of a separate network altogether. Since the WLAN controller 34 manages the local network 32, it has information concerning the various devices connected to the local network 32.

In response to the emergency communication 100, the emergency response center 14 sends a location inquiry 104 to the WLAN controller 34. The WLAN controller 34 collects information needed to estimate the calling device's location directly from the local network 32, estimates that location, and returns a location estimate 112 to the emergency-response center 14. The emergency-response center 14 then uses this location estimate 112 to dispatch emergency responders.

Concurrent with or after updating the emergency-response center 14, the WLAN controller 34 provides the notifier 18 with first information 110 for use by the notifier 18 in generating the recipient list 31. The notifier 18 then operates as already described in connection with FIG. 2.

As discussed in connection with FIG. 4, it is possible for the WLAN controller 34 to interrogate the local network 32 in an effort to detect the location of a particular device 20 that made an emergency call 100. However, an emergency call 100 is not a prerequisite to the WLAN controller's ability to detect the device 20. The WLAN controller 34 could easily have detected the device 20 just because the device 20 was detected by or connected to the local network 32.

With this in mind, it is not inconceivable for the WLAN controller 34 to detect and locate all devices known to the local network 32, even if none of them have actually made an emergency call 100. This may be useful, for example, in case of evacuation.

As an example, suppose that building 13 is a beachfront hotel. It is possible for the notifier 18 to receive an emergency call indicating that, as a result of an earthquake, a tsunami is headed for the building 13. In that case, it would be a good idea to alert everyone who is connected to the building's local network 32 that they should consider moving to higher ground.

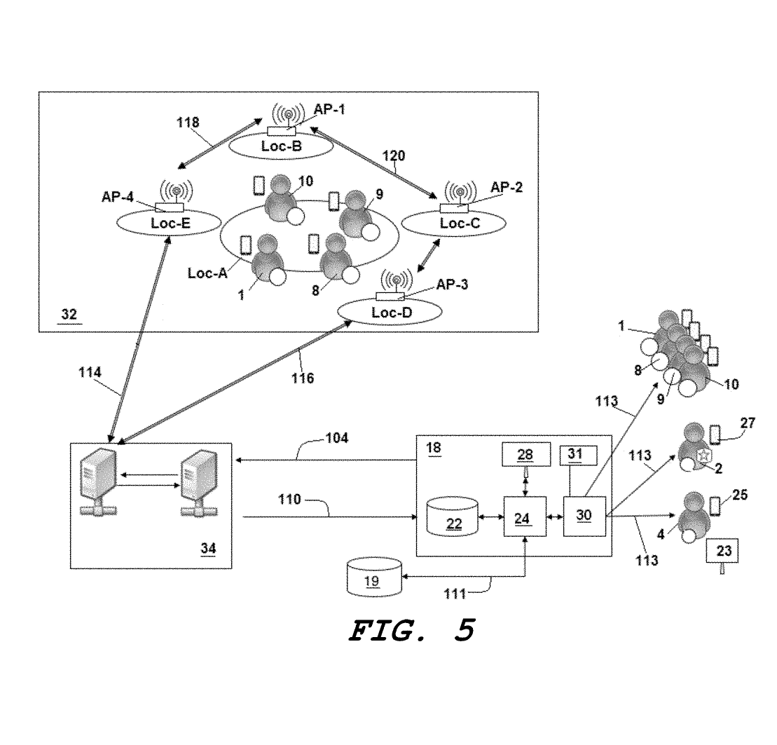

FIG. 5 shows the apparatus of FIG. 4 carrying out this type of notification procedure following receipt by the notifier 18 of an emergency communication. To simplify the figure, the emergency communication itself is not shown. That call could come from any source.

In response to receiving an emergency communication, the notifier 18 sends a message to the WLAN controller 34 asking for a list of all devices connected the local network 32 that the WLAN controller 34 controls. The WLAN controller 34 then interrogates the local network 32 and transmits suitable first information 110 to the notifier 18.

Upon receiving the first information 110, the notifier proceeds as already described in connection with FIG. 4. As shown in FIG. 5, the notification list 31 would include all the devices that were connected to the local network 32 at the time the WLAN controller 34 interrogated the local network 32.

In some cases, the notification list can be reduced by filtering the set of devices that the WLAN controller 34 identified. This filtering can be carried out based on the second information 111.

Although FIG. 5 only shows one local network 32 being queried, it is possible for the notifier 18 to communicate with more than one WLAN controller 34 so that different local networks 32 can be interrogated. These queried networks can be in the same location or at different locations. In addition, these queried networks can be interconnected or separate.

Having described the invention, and a preferred embodiment thereof, what is claimed as new, and secured by letters patent is:

1. A method comprising processing an emergency communication, wherein processing said emergency communication comprises receiving said emergency communication, receiving information indicative of a location of an emergency, providing said received information to a configurable rule set, using said configurable rule set, generating a recipient list that identifies at least one recipient of a notification message based on said received emergency communication, and distributing said notification message to at least one recipient from said recipient list, wherein receiving information indicative of a location of an emergency comprises receiving information indicative of a device that was used to convey said emergency communication.

2. The method of claim 1, wherein receiving said emergency communication comprises receiving an emergency call placed from a mobile device.

3. The method of claim 1, wherein receiving said emergency communication comprises receiving a text message

4. The method of claim 1, wherein receiving said emergency communication comprises receiving an alarm signal transmitted by an alarm-actuator.

5. The method of claim 4, wherein receiving an alarm signal transmitted by an alarm-actuator comprises receiving an indication that a panic button on a device has been pressed.

6. The method of claim 5, wherein said panic button is displayed on a screen of said device.

7. The method of claim 1, wherein receiving said emergency communication comprises receiving a signal indicative of expiration of a safety timer.

8. The method of claim 1, wherein receiving said emergency communication comprises receiving a signal indicative of one of an abnormal event and an unsafe event.

9. The method of claim 1, wherein generating said recipient list comprises including, in said recipient list, a device that is able to communicate with at least one emergency responder.

10. The method of claim 1, wherein generating said recipient list comprises including, in said recipient list, all devices connected to a particular local area network that has been identified based on information in said emergency communication.

11. The method of claim 1, wherein generating said recipient list comprises including, in said recipient list, devices associated with all persons in a particular area, said particular area having been identified based on information in said emergency communication.

12. The method of claim 1, wherein generating said recipient list comprises identifying all persons in a list of persons, said list of persons having been identified based on information in said emergency communication.

13. The method of claim 1, wherein generating a recipient list comprises including, in said recipient list, a digital sign.

14. The method of claim 1, wherein receiving information indicative of a location of an emergency comprises receiving said information from said received emergency communication.

15. The method of claim 14, wherein receiving information indicative of a location of an emergency comprises using the National Emergency Address Database to obtain said location.

16. The method of claim 1, wherein receiving information indicative of a location of an emergency comprises evaluating a unique identifier of a wireless signal-originating access point discovered by a mobile device that has sent said emergency communication, and inferring a location based on said unique identifier.

17. The method of claim 1, wherein receiving information indicative of an emergency comprises receiving said information from said emergency communication.

18. The method of claim 1, wherein receiving information indicative of an emergency comprises requesting said information in response to said emergency communication.

19. The method of claim 1, wherein receiving information indicative of an emergency comprises requesting said information from a network that was used during conveyance of said emergency communication.

20. The method of claim 1, wherein distributing a notification message comprises evaluating a mode by which a notification is to be sent to a notification recipient from said recipient list and, using said mode, sending said notification message to said notification recipient.

21. The method of claim 1, further comprising using said rule set to evaluate the nature of said reported emergency.

22. The method of claim 1, further comprising, based on said rule set, evaluating an attribute of said caller.

23. The method of claim 1, wherein processing said emergency communication comprises relying, at least in part, on service provided by a wireless public telephone network.

24. The method of claim 1, wherein processing said emergency communication comprises avoiding reliance on service provided by a wireless public telephone network.

25. The method of claim 1, further comprising configuring said rule set through a user-interface.

26. The method of claim 1, wherein receiving information indicative of a device comprises receiving information indicative of a signal strength of said device.

27. The method of claim 1, wherein receiving information indicative of a device comprises receiving information indicative of a unique identifier of said device.

28. The method of claim 1, wherein receiving information indicative of a device comprises receiving information indicative of a location of said device.

29. The method of claim 1, wherein generating a recipient list comprises including, in said recipient list, a siren.

30. An apparatus for processing emergency communications, said apparatus comprising a processing system and memory in data communication with said processing system, wherein said processing system is configured to receive information indicative of a location of an emergency, wherein said information indicative of a location of an emergency comprises information concerning a device that was used to convey an emergency communication, wherein said processing system further comprises a machine-readable medium having encoded thereon data representative of a configurable rule set, wherein said configurable rule set comprises rules that cause said processing system to generate a recipient list based at least in part on said received information concerning a device, wherein said recipient list identifies at least one recipient of a notification message, and wherein said processing system is further configured to distribute said notification message to said at least one recipient.

31. The apparatus of claim 30, wherein said processing system is further configured to receive, from a location-determining platform, information indicative of location from which said emergency communication originated.

32. The apparatus of claim 30, wherein said processing system is further configured to receive information indicative of at least one wireless access point and to infer a location from which said emergency communication originated based at least in part on said information.

33. A manufacture comprising a tangible and non-transitory computer-readable medium having encoded thereon instructions that, when executed by a digital computer processing system, cause said digital computer processing system to extract information from a received emergency communication, to execute at least one rule from a configurable rule set having rules that cause said processing system to generate a recipient list that identifies at least one recipient of a notification message, and to distribute said notification message to said at least one recipient.
